(19) United States
(12) Patent Application Publication
(10) Pub. No.: US 2014/0029654 A1
(43) Pub. Date: Jan. 30, 2014

(54) METHOD AND APPARATUS FOR CHARACTERIZING IMPULSE NOISEAND OPTIMIZING DATA LINK EFFICIENCY

(71) Applicants: Robert J. Thompson, Monroeton, PA (US); Charles S. Moore, Langhorne, PA (US); John L. Moran, III, Millville, MA (US); Marc L. Morrissette, Plainville, MA (US)

(72) Inventors: Robert J. Thompson, Monroeton, PA (US); Charles S. Moore, Langhorne, PA (US); John L. Moran, III, Millville, MA (US); Marc L. Morrissette, Plainville, MA (US)

(73) Assignee: GENERAL INSTRUMENT CORPORATION, Horsham, PA (US)

(21) Appl. No.: 13/562,257

(22) Filed: Jul. 30, 2012

(51) Int. Cl. H04L 12/26; H04B 1/38

(52) U.S. Cl. 375/222; 375/227

(57) ABSTRACT

Method and apparatus for characterizing an impulse noise impairment impacting communications over data links of a network are provided. A test signal comprising a bit stream of a predetermined bit sequence and packet size is configured and transmitted over the data links. The test signal is received, and the bit stream of the test signal as transmitted is compared to a bit stream of the test signal as received to identify differences in bit sequence. Thereafter, characteristics of the impulse noise impairment impacting communications between the data links are estimated based on the detected differences in bit sequence.

### BACKGROUND

Program providers, multiple system operators, television networks and stations, cable TV operators, satellite TV operators, studios, wireless service providers, and Internet broadcasters/service providers, among others, may operate broadband communication systems to deliver programming and like content to consumers/subscribers over networks via digital or analog signals. Such networks and physical plants can be extensive and complex and are typically difficult for an operator to manage and monitor for faults, impairments, and like issues.

A cable network, for instance, may include a headend which is connected to several nodes that may provide access to IP or ISPN networks. The headend typically interfaces with a cable modem termination system (CMTS) which has several receivers with each receiver connecting to numerous nodes each of which connect to numerous terminal network elements, such as modems, MTA (media terminal adaptors), set top boxes, terminal devices, customer premises equipment (CPE) or like devices of subscribers. By way of example, a single receiver of the CMTS may connect to several hundred or more terminal network elements, such as cable modems, and each cable modem may support data connection to the Internet and other computer networks via the cable network. In this regard, the cable network provides a bi-directional communication system in which data can be sent downstream from the headend to a subscriber and upstream from a subscriber to the headend.

One particular problem that can have an impact on communications over such networks is impulse noise. Impulse noise is a transient ingress event that is bursty in nature and produces an interference that is of finite duration and that may be periodic or with repetitive frequency of occurrence. For example, an impulse noise event may be of a duration of about 1 microsecond to a few tens of microseconds and will typically have a fast rise time and at least a moderately fast fall time. It is an impairment that primarily impacts upstream communications on a network, for instance, upstream communications transmitted by cable modems on a DOCSIS communication system to headend equipment. The term DOCSIS (Data Over Cable System Interface Specification) refers to a group of specifications that define industry standards for cable headend and cable modem equipment.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a simplified schematic view of a cable network according to an embodiment.

FIG. 2 is a diagram of process steps of a method for characterizing impulse noise according to an embodiment.

FIG. 3 is a diagram of a bit stream of a test signal according to an embodiment.

FIG. 4 is a diagram of a theoretical waterfall curve for 64-QAM for use in estimating magnitude of impulse noise according to an embodiment.

### DETAILED DESCRIPTION

Accurately diagnosing impulse noise has conventionally been problematic. For example, a standard sine-swept spectrum analyzer maximum hold trace can be used to indicate the presence of impulse noise in an upstream hybrid fiber/coaxial (HFC) cable network. However, such a spectrum analyzer has limitations in its ability to accurately determine the magnitude, duration and periodicity of an impulse noise event and can lead to false conclusions regarding the occupied frequency and bandwidth of the impulse noise event. Thus, use of a spectrum analyzer in this manner may not accurately predict the expected upstream signal deterioration that results from the impulse noise event.

Frequency and/or time domain analysis and self-triggered high-speed oscilloscopes may be used to estimate impulse noise characteristics. However, such analysis may not fully account for communication system configurations and profiles which may lead to inaccurate estimates. More accurate impulse noise characterization may be capable of being achieved with vector signal analyzers (VSA). While vector signal analyzers have been in existence for decades, such analyzers have typically been designed for use in a laboratory. Some recent VSA design concepts have been expanded to accommodate CATV headend environments; however, cable operators have not found VSA technology suitable for deployment in the field, for reasons such as cost and training for technicians to use and deploy such equipment.

Forward Error Correction (FEC) is a method of error detection and correction in which redundant information is transmitted with a data payload to allow a receiver to reconstruct original data if an error occurs during transmission. Thus, FEC is a DOCSIS tool that can be used to mitigate the impact of impulse noise impairments. As an illustrative example, consider a 64 byte packet, which equates to 512 bits. For a modulation profile using 64-QAM (quadrature amplitude modulation), a 64 byte packet is transmitted using eighty-five 64-QAM symbols, with 6 bits per 64-QAM symbol. Given a transmission rate of 5.12 Msym/s, each symbol represents a period of 192 nsec and the 64 byte packet covers a span of 16.3 msec. FEC at its “t” configuration can correct 16 bytes for an impulse duration of 4 μsec assuming the impulse noise is sufficiently strong to cause bit errors.

FEC configurations may be tuned to correct for consecutive errors associated with impulse noise impairments. However, inaccurate characterization of impulse noise can lead to FEC configurations which degrade cable network efficiency. For example, use of too much FEC typically adds to network overhead and reduces available throughput for paying services. In contrast, use of too little FEC typically results in high uncorrected codeword error rates (UCER) resulting in dropped packets and retransmission of information also impacts network efficiency.

For simplicity and illustrative purposes, the principles of embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Aspects of the present disclosure include a method of characterizing an impulse noise impairment impacting communications over data links of a network by configuring a test signal comprising a bit stream of a predetermined bit sequence and packet size that is transmitted over the data links, receiving the test signal transmitted over the data links, and comparing the bit stream of the test signal as transmitted to a bit stream of the test signal as received to identify differences in bit sequence. Thereafter, characteristics of the impulse noise impairment impacting communications between the data links are estimated based on the detected differences in bit sequence.

Aspects of the present disclosure further include a signal processing electronic device for characterizing an impulse noise impairment impacting communications over data links of a network. The device has at least one processing unit configured to receive a test signal that comprises a bit stream of a predetermined bit sequence and packet size and that is transmitted over the data links, and to compare the bit stream of the test signal as transmitted to a bit stream of the test signal as received to identify differences in bit sequence. The at least one processing unit is further configured to estimate characteristics of the impulse noise impairment impacting communications between the data links based on the detected differences in bit sequence.

Aspects of the present disclosure still further include at least one non-transitory computer readable storage medium having computer program instructions stored thereon that, when executed by at least one processor, cause the at least one processor to configure a test signal comprising a bit stream of a predetermined bit sequence and packet size for being transmitted from one end of the data links to an opposite end of the data links and for being received at the opposite end of the data links and to compare the bit stream of the test signal as transmitted to a bit stream of the test signal as received to identify differences in bit sequence. The computer program instructions also cause the at least one processor to estimate characteristics of the impulse noise impairment impacting communications between the data links based on the detected differences in bit sequence.

According to an embodiment, network apparatus and methods are used to leverage the existing DOCSIS infrastructure of a network to converge upon impulse noise characterization, in particular, to provide an estimation of the magnitude, duration and periodicity of an impulse noise impairment. This is accomplished by an efficient process in which known bits (1s and 0s) of a test signal as transmitted over data links (i.e., before the known signal has been impacted by impulse noise) is compared to the bits of the test signal as received (i.e., after the known signal has been impacted by impulse noise). Accordingly, this before and after comparison process for characterizing impulse noise significantly reduces system complexity by eliminating spectrum and/or vector signal analysis functions from the characterization process. While this process is described herein particularly with respect to a DOCSIS system, it may be implemented with any similar communication network protocol in a similar manner to achieve similar results.

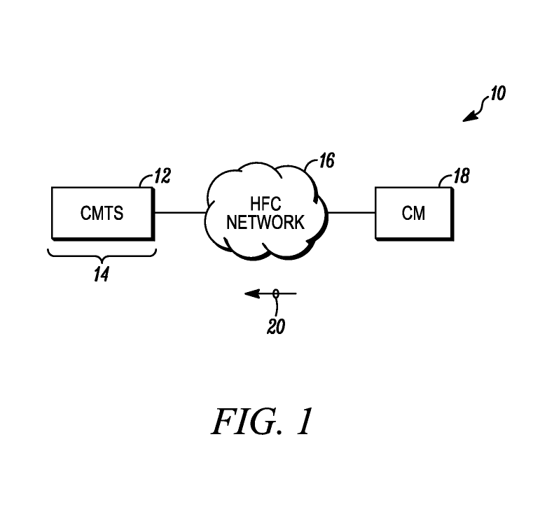

For purposes of providing an example of a network, a cable network 10 is shown in FIG. 1 having a CMTS 12 at a headend 14 of the cable network 10. In the example shown in FIG. 1, the CMTS 12 is able to send and receive communications from terminal network elements at subscriber sites via HFC network infrastructure 16. As an example of a terminal network element, cable modem 18 is shown in FIG. 1 with arrow 20 defining the direction of transmissions defined as “upstream” transmissions (from the cable modem 18 to the CMTS 12). The generalized diagram of FIG. 1 is provided for purposes of example only and various other types of networks and network configurations and types of network equipment and components are possible.

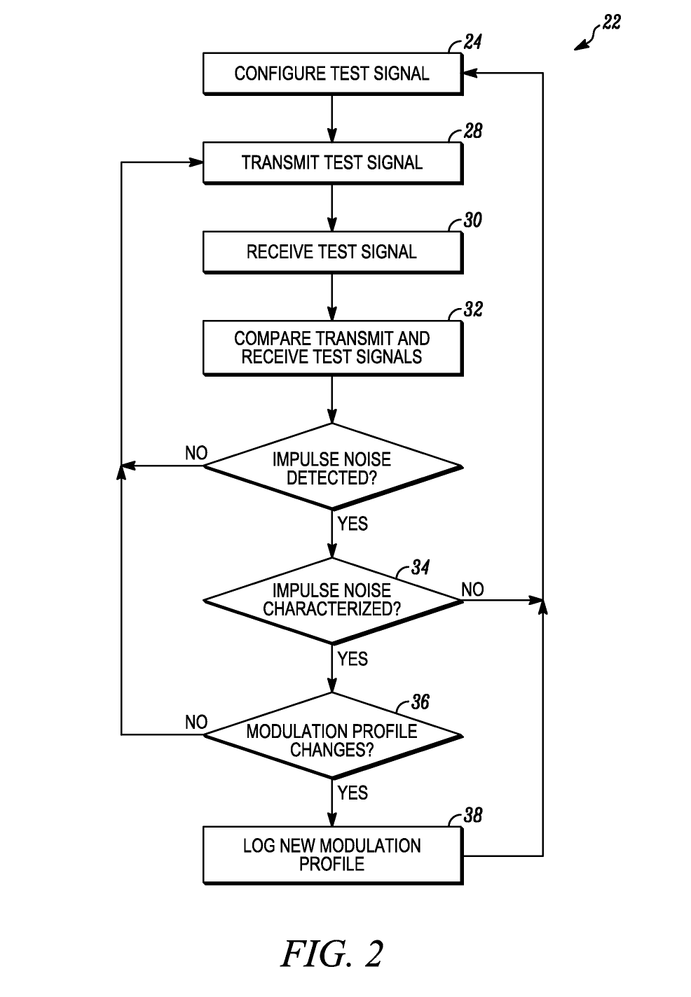

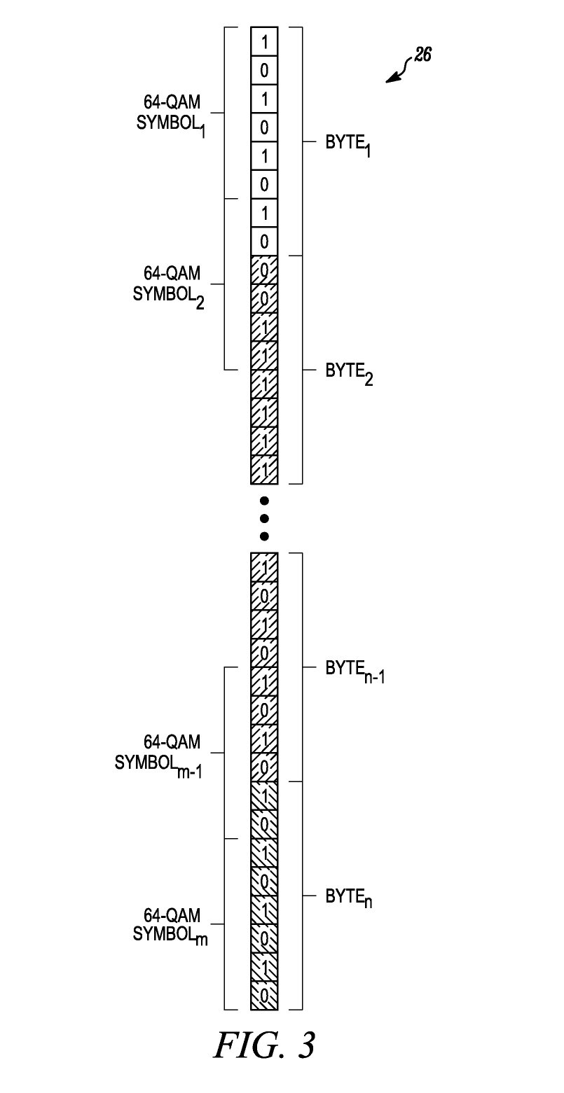

The diagram shown in FIG. 2 provides an example of a process 22 of an embodiment for characterizing impulse noise impairments that may occur on the network 10. A first step 24 of the process 22 is to configure a test signal to be transmitted by the cable modem 18 to the CMTS 12. For example, a known configuration and bit sequence can be provided in the form of alternating 1s and 0s. Of course, this is merely an example and any bit sequence may be used. Solely for purposes of example, see Byte' in FIG. 3 for a pattern of alternating 1s and 0s. This sequence can be repeated throughout the entire test signal for use as a configured test signal to be transmitted. Accordingly, regardless of the sequence selected, the test signal can include a stream 26 of bits including Byte₁ to Byteₙ defining symbols 64-QAM Symbol₁ to 64-QAM Symbolₘ.

In step 28 of FIG. 2, the known configuration and bit sequence of the test signal is transmitted through the cable network 10 and is exposed to an impulse noise impairment, assuming the network is subject to an impulse noise event. A receiver (not shown) of the CMTS 12 receives the test signal in step 30 and the known bit sequence, as originally transmitted, is compared in step 32 to the bit sequence as actually received by the CMTS 12. This comparison of known configured signal to received signal is used to access impulse noise characteristics. Accordingly, since all measurements are performed directly on any DOCSIS data link, inaccuracies associated with interpreting for specific modulation profiles, configuration settings, and test conditions are simply avoided. Thus, the comparison of step 32 provides an efficient process capable of providing accurate estimates of impulse noise characteristics.

In the event that impulse noise is not detected during the comparison of step 32, then the CMTS 12 may direct the cable modem 18 to re-transmit the test signal as provided by step 28 in FIG. 2. Alternatively, if impulse noise is detected based on the comparison used in step 32, further processing of the received signal is performed whereby estimates of one or more of the magnitude, duration, and periodicity of the impulse noise are produced.

Multiple iterations of the above described steps may be required to converge upon an accurate estimate of the above characteristics. Additionally, modifications to the test signal as configured in step 24 may be required to successfully converge upon the impulse noise characteristics. See step 34. For example, longer test sequences may be required to fully capture an impulse noise event having a relatively long duration.

After impulse noise characteristics have been estimated, an optional further step is to estimate and optimize FEC profile settings required to fully mitigate the impulse noise impairment identified during the test. See steps 36 and 38 in FIG. 2.

In addition, the obtained estimate of impulse noise characteristics and signature can be used in an effort to predict and pinpoint the likely source of the noise. For example, how various household and other noise sources generate impulse noise characteristics can be defined. By way of example, a database of common impulse noise signatures paired with possible or suspected sources can be populated and used for comparison purposes to predict and pinpoint the likely source of the noise. For instance, hair dryers, light switches, automotive ignition circuits, and the like may be a source of noise and each will have a relatively unique signature. Thus, after impulse noise characteristics are estimated (such as accomplished in step 34 of FIG. 2), the signature of the estimated impulse noise impairment can be compared with known or expected signatures stored in the above referenced database to identify the most similar signature and thereby predict the likely source of the noise.

In this manner, cable operators can be given clues as to where they may find cable network defects contributing to impulse noise impairments within their network. Thus, the process described herein can be used as a tool for quickly and efficiently estimating the type of source of the impulse noise and its probable location.

With such information, preventive steps can be taken by a subscriber or customer to identify the actual source of the impulse noise and prevent further events. In this regard, the characterization may be used to solve an impulse noise problem at its source as opposed to merely determining an optimum FEC setting.

With respect to estimating a duration characteristic of an impulse noise event, the following example is provided. In this example, the configured test signal provided by step 24 is a sequence of alternating 1s and 0s that is transmitted, received and compared in steps 28, 30 and 32 of FIG. 2 as discussed above. The received test signal is as shown for stream 26 in FIG. 3. Analysis of Byte₁, Byteₙ₋₁ and Byteₙ, for instance, indicates that the sent and received signals are identical and are not subject to impulse noise. However, analysis may reveal, for instance, that ten 64-QAM symbols were in error. For example, note that Byte₂ of the received stream 26 in FIG. 3 clearly shows signs of being affected by an impulse noise event.

In this example, given 64-QAM, 5.12 Msym/s, the duration of the impulse event may be estimated as 10 symbols*192 nsec=1.92 μsec. Consequently, FEC can be configured to correct for 8 bytes in step 38 of FIG. 2.

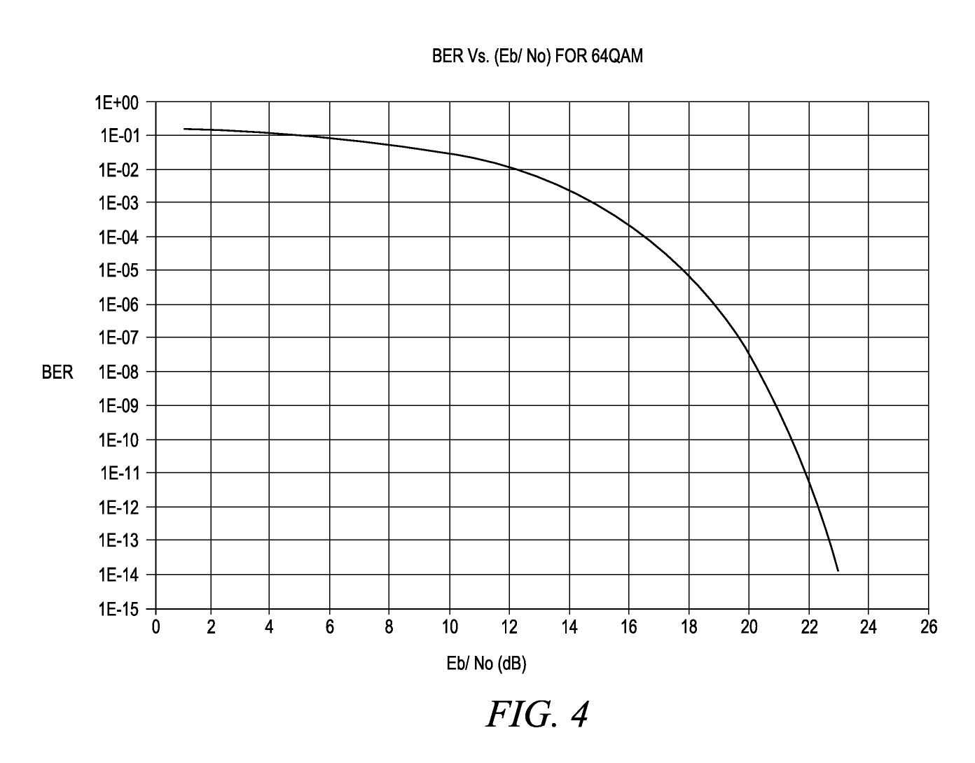

Similar processes can be used to produce estimates that characterize magnitude and periodicity of impulse noise impairments. For example, estimations for magnitude of impulse noise can be made based upon the modulation level employed and the concentration of errors detected within the bit stream. As shown in FIG. 4, a theoretical waterfall curve that associates bit-error-rates (BERs) with expected Signal-to-Noise ratios for a given modulation profile may be used. In FIG. 4, the modulation profile is 64 QAM, the y-axis is provided as BER, and the x-axis is provided as energy per bit (Eb) to noise power spectral density (No) ratio (Eb/No) measured in dBs.

As an example, consider a modulation profile employing the use of 64-QAM, and an impulse noise event whose observed BER=1e−1. This means that every two 64-QAM symbols will have at least one bit in error. Based on the data provided in the waterfall curve of FIG. 4, the SNR associated with the impulse noise event would be approximately 4 dB+10*log₁₀(6)=11.78 dB. Furthermore, queries may be made via SNMP report that may indicate the level in which the DOCSIS terminal device is transmitting signals is, for instance, 47 dBmV. Therefore, subtracting 11.78 dB from 47 dBmV provides an estimate of magnitude of the impulse noise event of 47−11.78=35.22 dBmV. Further confidence in the estimate may be realized through comparison in the estimated impulse noise magnitude and the observed modulation error ratio (MER) of the DOCSIS link. Generally, expected impulse noise magnitude will be worse than the reported MER for the DOCSIS link. This provides one illustration of characterizing impulse noise magnitude; however, more advanced methods for estimation can also be employed, as desired, to improve estimation performance.

Estimations for impulse noise periodicity can be made through observation of the number of unerrored symbols between detected impulse noise events. As an example, if two detected impulse noise events are separated by approximately 52 symbols, then an estimate for periodicity can made using CMTS configuration information settings. If the CMTS is configured for 5.12 Msps, then the time for each symbol is approximately 195 ns. Since there were 52 error-free symbols between detected impulse noise events, then the estimated periodicity is simply 52×195 ns, or 10 μs. This provides one illustration of characterizing impulse noise periodicity; however, more advanced methods for estimation can also be employed, as desired, to improve estimation performance.

In addition to modifying FEC settings and or predicting sources of the impulse noise, the process and apparatus may cause alarms to be automatically raised to alert network operators when impulse noise characteristics exceed a level that may be capable of being adequately compensated for via use of FEC. The alarm may result in trouble tickets or some other mitigation strategy, such as predicting and attempting to eliminate the source of the noise as discussed above.

If no changes to the modulation profile are required (for instance, during step 34 of FIG. 2), the system may continue to monitor the network and evaluate future opportunities for FEC configuration improvements. However, if new modulation profile settings are required (for instance, during step 38 of FIG. 2), such settings can be logged, implemented, and monitored for sustainable improvement.

The configured test signal is assumed to be comprised of a known bit sequence and packet size predetermined by network apparatus for ease of characterization and is by nature used during an out-of-service test. For instance, testing can be performed during a maintenance window to ensure that disruption of actively running services is avoided. However, in some contemplated embodiments, implementations of the above method may be performed in conjunction with actively running services. For example, preamble information from existing services could be leveraged to perform the above referenced tests.

The steps and analysis described for the above referenced method may be controlled by software or like application adapted to run on a CMTS, a remote server, or some other signal processing electronic device connected to the CMTS and/or the network. Such a signal processing electronic device for carrying out the methods can physically be provided on a circuit board or within another electronic device and can include various processors, microprocessors, controllers, chips, and the like. It will be apparent to one of ordinary skill in the art that modules, processors, controllers, units, and the like may be implemented as electronic components, software, hardware or a combination of hardware and software. In addition, a non-transitory computer readable storage medium having computer program instructions stored thereon that, when executed by a processor, causes the processor to perform the above discussed operations can also be provided

While the principles of the embodiment have been described above in connection with specific networks, devices, apparatus, systems, and methods, it is to be clearly understood that this description is made only by way of example and not as limitation on the scope of the invention as defined in the appended claims.

We claim:

1. A method of characterizing an impulse noise impairment impacting communications over data links of a network, comprising the steps of:
configuring a test signal comprising a bit stream of a predetermined bit sequence and packet size that is transmitted over the data links;
receiving the test signal transmitted over the data links;
comparing the bit stream of the test signal, as transmitted, to a received bit stream of the test signal, as received during said receiving step, to identify differences in bit sequence; and
estimating characteristics of the impulse noise impairment impacting communications between the data links based on the differences in bit sequence detected during said comparing step.

2. The method according to claim 1, wherein the characteristics estimated during said estimating step include at least one of impulse noise duration, impulse noise magnitude and impulse noise periodicity.

3. The method according to claim 1, wherein the predetermined bit sequence consists of a known sequence of 1s and 0s that define an array of quadrature amplitude modulation (QAM) symbols.

4. The method according to claim 3, wherein the differences in bit sequence identified in said comparing step are analyzed during said estimating step to determine a number of QAM-symbols in the test signal, as received, in error.

5. The method according to claim 4, wherein the number of QAM-symbols in error in the test signal, as received, is used to estimate duration of the impulse noise impairment by multiplying the number of QAM-symbols in error by a rate of transmission of each QAM-symbol.

6. The method according to claim 1, wherein said steps of receiving, comparing and estimating are repeated for multiple iterations over a period of time to converge on an estimate of the characteristics of the impulse noise impairment.

7. The method according to claim 1, further comprising the steps of modifying the test signal configured during said configuring step and, after said modifying step, repeating said steps of receiving, comparing and estimating with use of the test signal as modified during said modifying step.

8. The method according to claim 1, further comprising the step of automatically determining and implementing optimal forward error correction (FEC) settings needed to compensate for the impulse noise impairment based on the estimated characteristics of the impulse noise impairment estimated during said estimating step.

9. The method according to claim 8, further comprising the step of automatically raising an alarm if the impulse noise impairment impacting communications over the data links, as estimated during said estimating step, cannot be adequately corrected by adjusting available FEC settings.

10. The method according to claim 1, further comprising the step of predicting a source of the impulse noise impairment by comparing the characteristics of the impulse noise impairment provided during said estimating step with known signatures of impulse noise impairments produced by suspected sources.

11. The method according to claim 1, wherein said receiving step is performed during a maintenance window of the data links of the network.

12. The method according to claim 1, wherein said receiving step is performed simultaneously with actively running services over the data links of the network by including the test signal in preamble information of the actively running services.

13. The method according to claim 1,
wherein the test signal transmitted is from a cable modem,
wherein the test signal received during the receiving step is received by a cable modem termination system (CMTS), and
wherein a communication protocol used by the cable modem and CMTS for transmitting and receiving the test signal is Data Over Cable System Interface Specification (DOCSIS).

14. A signal processing electronic device for characterizing an impulse noise impairment impacting communications over data links of a network, the signal processing electronic device comprising:
at least one processing unit configured
to receive a test signal that comprises a bit stream of a predetermined bit sequence and packet size and that is transmitted over the data links;
to compare the bit stream of the test signal, as transmitted, to a received bit stream of the test signal, as received;
to identify differences in bit sequence; and
to estimate characteristics of the impulse noise impairment impacting communications between the data links, based on the differences in bit sequence detected.

15. The signal processing electronic device according to claim 14,
wherein the signal processing electronic device is selected from a group consisting of a cable modem termination system (CMTS) and a server, and
wherein the characteristics estimated include at least one of impulse noise duration, impulse noise magnitude and impulse noise periodicity.

16. The signal processing electronic device according to claim 14, wherein the at least one processing unit is further configured
to analyze the differences in bit sequence to determine a number of QAM-symbols in the test signal, as received, in error and
to estimate duration of the impulse noise impairment by multiplying the number of QAM-symbols in error by a rate of transmission of each QAM-symbol, and
wherein the at least one processing unit is configured to modify the test signal to be transmitted.

17. The signal processing electronic device according to claim 14, wherein the at least one processing unit is further configured
to automatically determine and implement optimal forward error correction (FEC) settings needed to compensate for the impulse noise impairment based on the estimated characteristics of the impulse noise impairment, and
wherein the at least one processing unit is configured to automatically raise an alarm if the impulse noise impairment impacting communications over the data links as estimated cannot be adequately corrected by adjusting available FEC settings.

18. The signal processing electronic device according to claim 14, wherein the at least one processing unit is further configured
to automatically compare the characteristics of the impulse noise impairment estimated with a plurality of known signatures of impulse noise impairments produced by suspected sources to identify a suspected source of the impulse noise impairment.

19. At least one non-transitory computer readable storage medium having computer program instructions stored thereon for characterizing an impulse noise impairment impacting communications over data links of a network, wherein the computer program instructions, when executed by at least one processor, cause the at least one processor to perform the following operations:
configure a test signal comprising a bit stream of a predetermined bit sequence and packet size for being transmitted from one end of the data links to an opposite end of the data links and for being received at the opposite end of the data links;
compare the bit stream of the test signal, as transmitted, to a received bit stream of the test signal, as received, to identify differences in bit sequence; and
estimate characteristics of the impulse noise impairment impacting communications between the data links based on the differences in bit sequence.

20. At least one non-transitory computer readable storage medium according to claim 19, wherein the computer program instructions, when executed by the at least one processor, cause the at least one processor to perform at least one of the following operations:
determine and implement optimal forward error correction (FEC) settings needed to compensate for the impulse noise impairment based on the estimated characteristics of the impulse noise impairment; and
compare the estimated characteristics of the impulse noise impairment with a plurality of known signatures of impulse noise impairments produced by suspected sources to predict a source of the impulse noise impairment estimated.
